(19) United States
(12) Patent Application Publication
(10) Pub. No.: US 2015/0378858 A1
(43) Pub. Date: Dec. 31, 2015

(54) STORAGE SYSTEM AND MEMORY DEVICE FAULT RECOVERY METHOD

(71) Applicant: HITACHI, LTD., Tokyo (JP)

(72) Inventors: Ryoma ISHIZAKA, Tokyo (JP); Tomohisa OGASAWARA, Tokyo (JP); Yukiyoshi TAKAMURA, Tokyo (JP); Yusuke MATSUMURA, Tokyo (JP)

(73) Assignee: HITACHI, LTD., Tokyo (JP)

(21) Appl. No.: 14/764,397

(22) PCT Filed: Feb. 28, 2013
(86) PCT No.: PCT/JP2013/055282

§ 371 Date: Jul. 29, 2015

(51) Int. Cl. G06F 11/20

(52) U.S. Cl. CPC G06F 11/2094; G06F 2201/85

(57) ABSTRACT

The present invention aims at providing a storage system capable of shortening the recovery time from failure while ensuring the reliability of data when failure occurs to a storage device. When failure occurs to a storage device, a recovery processing corresponding to the content of failure is executed for the blocked storage device. The storage device recovered via the execution of the recovery processing is subjected to a check corresponding to the operation status of the storage system or the failure history of the storage device.

### TECHNICAL FIELD

The present invention relates to a storage system and a failure recovery method of storage device.

### BACKGROUND ART

Along with the recent advancement of IT, improvement of performance, increase of capacity and reduction of costs of storage systems as storage devices have also been enhanced. The storage systems are equipped with storage devices, such as multiple HDDs (Hard Disk Drives) arranged in arrays. The logical configuration of the storage devices is constructed based on RAID (Redundant Array of Independent (Inexpensive) Disks), according to which the reliability of the storage systems is maintained. A host computer can read and write data from/to the storage device by issuing a write or read I/O access command to the storage system.

Further, the storage system is required to ensure early recovery from failure. However, once failure occurs to the HDD within the storage system and the HDD is blocked, the failure HDD must be replaced by a maintenance personnel, and a long period of time was required for the HDD to return from a failure state to normal operation. However, a failed and blocked HDD may operate normally by turning the power on and off, or by executing a hardware reset operation.

Patent Literatures 1 and 2 disclose an art of turning the power on and off when failure occurs to an HDD before or after blockage of the HDD, and if the HDD is recovered thereby, resuming the operation using the recovered HDD.

Patent Literature 1 discloses executing hardware reset after the blocking of the HDD according to the type of failure, resuming the use of the disk as a spare disk after recovery of the HDD, and if hardware reset is to be performed without blocking the HDD, saving the difference caused by a write command in a cache, and reflecting the difference in the disk after recovery.

Patent Literature 2 discloses restarting the HDD without blocking the same if the failure is a specific failure, blocking the HDD when the HDD is not recovered, and as for the read command during restarting of the failure HDD, using the data in the HDD and a parity within the same RAID group, and as for the write command during restarting of the failure HDD, writing the data in a spare disk and rewriting the data in the disk after recovery from failure at the time of restart.

Patent Literature 3 discloses using correction copy processing and copy back processing in combination, and reducing the time required for recovering data in the HDD.

### CITATION LIST

### Patent Literature

### [PTL 1]

### United States Patent Application Publication No. 2006/0277445

### [PTL 2]

### United States Patent Application Publication No. 2009/0106584

### [PTL 3]

### United States Patent Application Publication No. 2006/0212747

### SUMMARY OF INVENTION

### Technical Problem

There are demands to shorten the recovery time of HDDs and other storage devices where failure has occurred, but on the other hand, the reuse of storage devices where failure has once occurred may deteriorate reliability from the viewpoint of reliability of the data and storage systems.

The object of the present invention is to provide a storage system and a failure recovery method of a storage device, capable of ensuring the reliability of data while shortening the recovery time from failure.

### Solution to Problem

In order to solve the above problems, when failure occurs to a storage device and the device is blocked, the present invention executes a recovery processing according to the content of failure to the blocked storage device. Then, the present invention executes a check according to the failure history of the recovered storage device or the status of operation of the storage system to the storage device recovered via the recovery processing.

### Advantageous Effects of Invention

The present invention enables to automatically regenerate and reuse the storage device in which a temporary failure has occurred, so that the enhancement of operation rate of the storage system and the reduction of maintenance steps and costs can be realized. Problems, configurations and effects other than those described above can be made clear based on the following description of preferred embodiments.

### BRIEF DESCRIPTION OF DRAWINGS

FIG. 1 is a view illustrating a concept of the present invention.

FIG. 2 is a configuration diagram of a storage system.

FIG. 3 is a view showing a configuration example of an error cause determination table.

FIG. 4 is a view showing a configuration example of a recovery count management table.

FIG. 5 is a view showing a configuration example of a recovery operation determination table.

FIG. 6 is a flowchart showing a recovery operation and check processing according to embodiment 1.

FIG. 7 is a flowchart showing a cause of error confirmation processing according to embodiment 1.

FIG. 8 is a view showing a first recovery operation of the failed drive.

FIG. 9 is a view showing a second recovery operation of the failed drive.

FIG. 10 is a view showing a configuration example of a maximum recovery count determination table.

FIG. 11 is a view showing a configuration example of a check content determination table.

FIG. 12 is a view showing a configuration example of an error threshold determination table.

FIG. 13 is a flowchart showing a recovery operation and check processing according to embodiment 2.

FIG. 14 is a flowchart showing a cause of error confirmation processing according to embodiment 2.

FIG. 15 is a view showing a configuration example of a data recovery area management table of a failed drive.

FIG. 16 is a view showing a configuration example of a data recovery area management table of a spare drive.

FIG. 17 is a view showing a third recovery operation of a failed drive.

FIG. 18 is a view showing a data and parity update operation in a fourth recovery operation of a failed drive.

FIG. 19 is a view showing a data recovery processing in a fourth recovery operation of a failed drive.

FIG. 20 is a view showing a fifth recovery operation of a failed drive.

FIG. 21 is a view showing a first redundancy recovery operation during reappearance of failure in a recovered drive.

FIG. 22 is a view showing a second redundancy recovery operation during reappearance of failure in a recovered drive.

FIG. 23 is a view showing a third redundancy recovery operation during reappearance of failure in a recovered drive.

### DESCRIPTION OF EMBODIMENTS

Now, the preferred embodiments of the present invention will be described with reference to the drawings. In the following description, various information are referred to as “management tables” and the like, but the various information can also be expressed by data structures other than tables. Further, the “management tables” can also be referred to as “management information” to show that the information does not depend on the data structure.

The processes are sometimes described using the term “program” as the subject. The program is executed by a processor such as an MP (Micro Processor) or a CPU (Central Processing Unit) for performing determined processes. A processor can also be the subject of the processes since the processes are performed using appropriate storage resources (such as memories) and communication interface devices (such as communication ports). The processor can also use dedicated hardware in addition to the CPU. The computer program can be installed to each computer from a program source. The program source can be provided via a program distribution server or a storage media, for example.

Each element, such as each storage device, can be identified via numbers, but other types of identification information such as names can be used as long as they are identifiable information. The equivalent elements are denoted with the same reference numbers in the drawings and the description of the present invention, but the present invention is not restricted to the present embodiments, and other modified examples in conformity with the idea of the present invention are included in the technical range of the present invention. The number of each component can be one or more than one unless defined otherwise.

### CONCEPT OF INVENTION

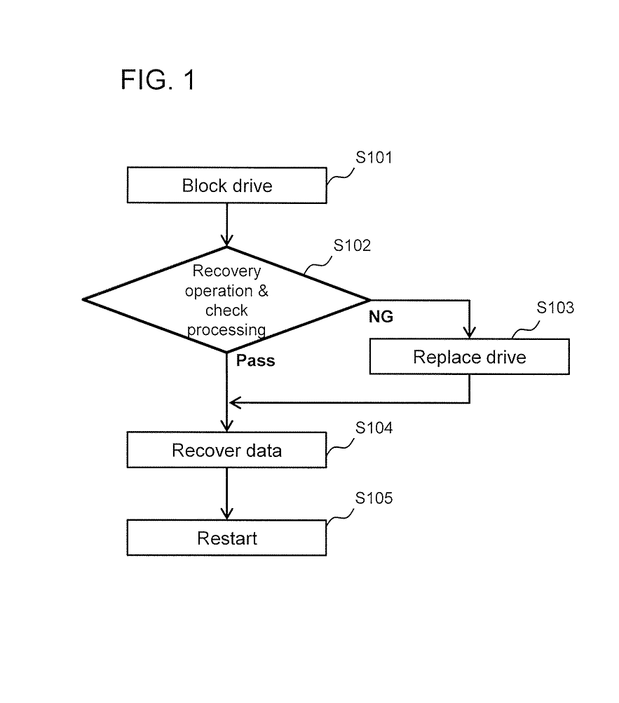

The concept of the present invention will be described with reference to FIG. 1.

According to the prior art, if a data drive (hereinafter referred to as drive) such as an HDD is blocked due to failure (hereinafter referred to as failed drive or blocked drive), at first, data is regenerated via a correction copy processing and stored in a spare drive (S101). Thereafter, a maintenance personnel replaces the failed drive with a normal drive (S103).

What is meant by blocked is that when failure of a drive has been determined, accesses to the failed drive are prohibited and the drive is set to non-usable state. Further, a correction copy processing is a processing for restoring a normal RAID configuration by generating data of the failed drive from other multiple normal drives constituting a RAID group and storing the same in another normal drive.

After drive replacement has been completed, data recovery is performed via copy back processing from a spare drive to the replaced normal drive (S104). A copy back processing is a processing for restoring a normal RAID configuration using only normal drives after recovering or replacing a failed drive and copying data stored in the spare drive to the replaced normal drive.

Lastly, a normal RAID group is restarted using only normal drives (S105). The required time from the above-mentioned drive blockage due to failure to the restoration of normal operation is, for example in the case of a SATA (Serial ATA) drive having a storage capacity of 3 TB (Tera Bytes), approximately 12 to 13 hours for the correction copy processing and approximately 12 hours for the copy back processing, so that a total of over 24 hours of copy time is required. Therefore, a maintenance personnel must be continuously present near the storage system for a whole day, and the maintainability was not good. Incidentally, the copy back processing is a copy processing performed via a simple read/write, and since it does not require a parity generation operation of read/parity generation/write as in correction copy processing, the copy time can be shortened.

Therefore, according to the present invention, a failed drive is automatically recovered as a normal drive via a recovery operation and check processing as shown in S102. A recovery operation is an operation for eliminating failure by executing one or a plurality of appropriate recovery operations with respect to a cause of error in the failed drive. A check processing is a check of a read or write operation performed to a recovered drive according to the redundancy of the RAID configuration or the data copy time, and whether the recovered drive should be reused or not is determined based on the result of this check. The details will be described below.

Based on the recovery operation and check processing of S102, a drive in which a temporary failure has occurred can be automatically regenerated and reused. Therefore, drive replacement by a maintenance personnel in S105 becomes unnecessary, according to which the operation rate of the storage system is improved, and the number of maintenance steps and the required costs can be cut down.

### <Storage System Configuration>

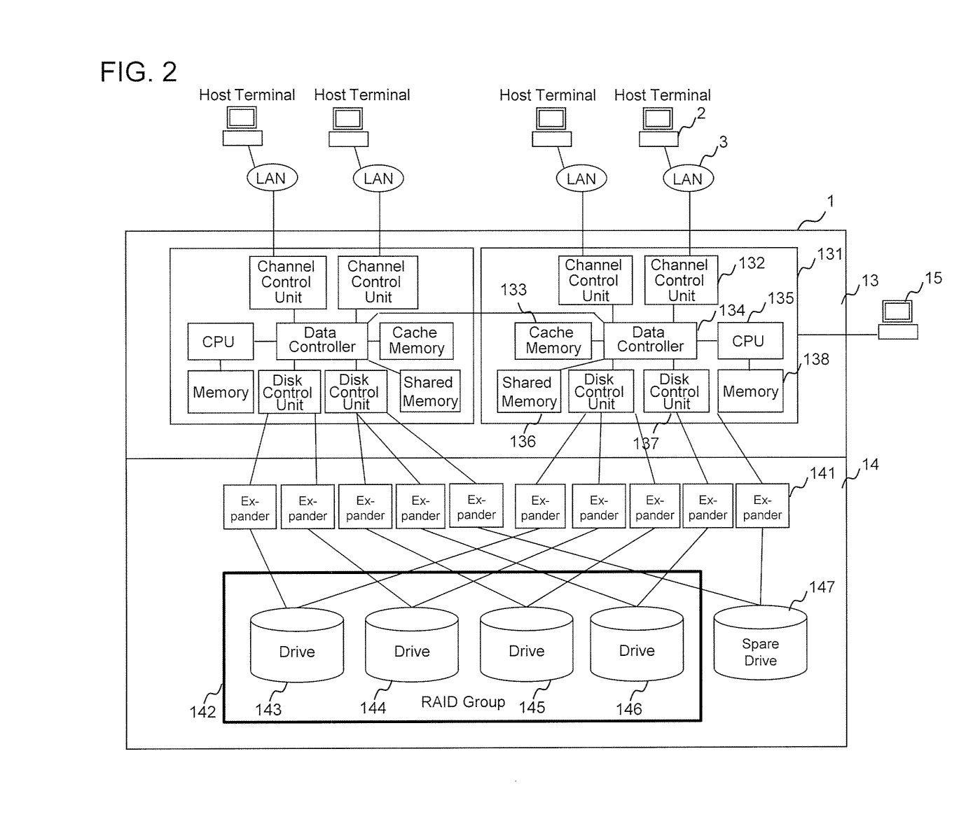

FIG. 2 is a configuration diagram of a storage system.

A storage system 1 according to the present invention is coupled to host terminals (hereinafter referred to as hosts) 2 via LANs (Local Area Networks) 3, and is composed of a disk controller unit 13 and a disk drive unit 14. The component composed of the disk controller unit 13 and the disk drive unit 14 is sometimes called a basic chassis, and the single unit of disk drive unit 14 is sometimes called an expanded chassis.

The user or the system administrator can increase the total storage capacity of the whole storage system 1 by connecting one or more expanded chassis to the basic chassis according to the purpose of use. The basic chassis and the expanded chassis are sometimes collectively called a chassis. A maintenance terminal 15 is coupled to the storage system 1, and the maintenance terminal 15 has a CPU, a memory, an output device for displaying the status of operation or failure information of the storage system 1 and the drives, an input device for entering set values and thresholds to determination tables, although not shown.

The disk controller unit 13 includes one or more controller packages 131. In FIG. 2, there are two controller packages 131 to enhance the reliability and the processing performance of the storage system 1, but it is also possible to provide three or more controller packages.

Further, the controller package 131 includes a channel control unit 132, a cache memory 133, a data controller 134, a CPU 135, a shared memory 136, a disk control unit 137, and a local memory 138.

The channel control unit 132 is a controller for performing communication with a host 2, which performs transmission and reception of an JO request command from a host 2, a write data to a data drive (hereinafter referred to as drive) 143 or a read data from the drive 143 or the like.

The cache memory 133 is a volatile memory or a nonvolatile memory such as a flash memory, which is a memory for temporarily storing user data from the host 2 or the like or the user data stored in the drive 143 or the like in addition to the system control information such as various programs and management tables.

The data controller 134 is a controller for transferring JO request commands to the CPU 135 or for transferring write data to the cache memory 133 and the like.

The CPU 135 is a processor for controlling the whole storage system 1.

The shared memory 136 is a volatile memory or a nonvolatile memory such as a flash memory, which is a memory shared among various controllers and processors, and storing various control information such as the system control information, various programs and management tables.

The disk control unit 137 is a controller for realizing communication between the disk controller unit 13 and the disk drive unit 14.

The local memory 138 is a memory used by the CPU 135 to access data such as the control information and the management information of the storage system or computation results at high speed, and is composed of a volatile memory or a nonvolatile memory such as a flash memory. The various programs and tables according to the present invention described later are stored in the local memory 138, and read therefrom when necessary by the CPU 135. The various programs and tables according to the present invention can be stored not only in the local memory 138 but also in a portion of the storage area of the drive 143 or in other memories.

The drive unit 14 is composed of a plurality of expanders 141, a plurality of drives (reference numbers 143 through 146), and one or more spare drives 147. There are two or more drives, which constitute a RAID group 142 such as a RAID5 adopting a 3D+1P configuration or a RAID6 adopting a 3D+2P configuration.

The expanders 141 are controllers for coupling a number of drives greater than the number determined by standard.

The drives 143 through 146 and a spare drive 147 are coupled to the disk control units 137 of the disk controller unit 13 via the expanders 141, and mutually communicate data and commands therewith.

The spare drive 147 is a preliminary drive used during failure or replacement of drives 143 through 146 constituting the RAID group 142. The drives 143 through 146 and the spare drive 147 can be, for example, an FC (Fiber Channel), an SAS (Serial Attached SCSI) or a SATA-type HDD, or a SSD (Solid State Drive).

### Embodiment 1

### Tables

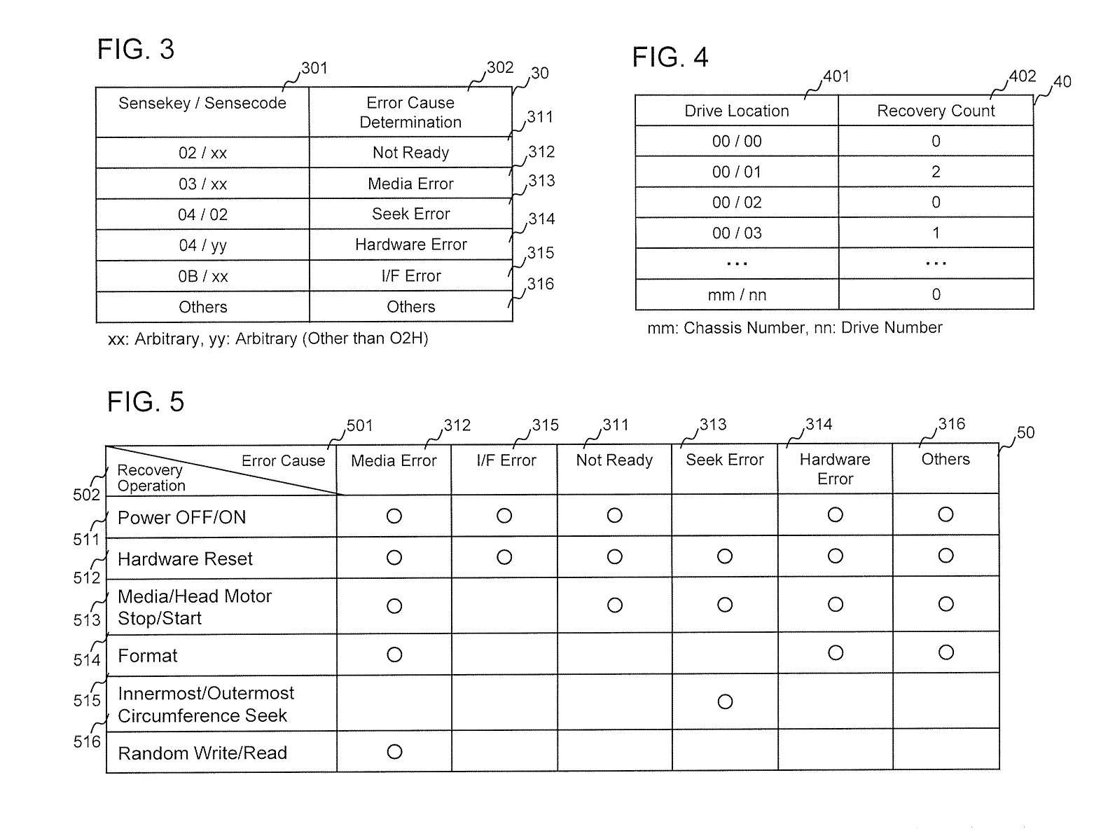

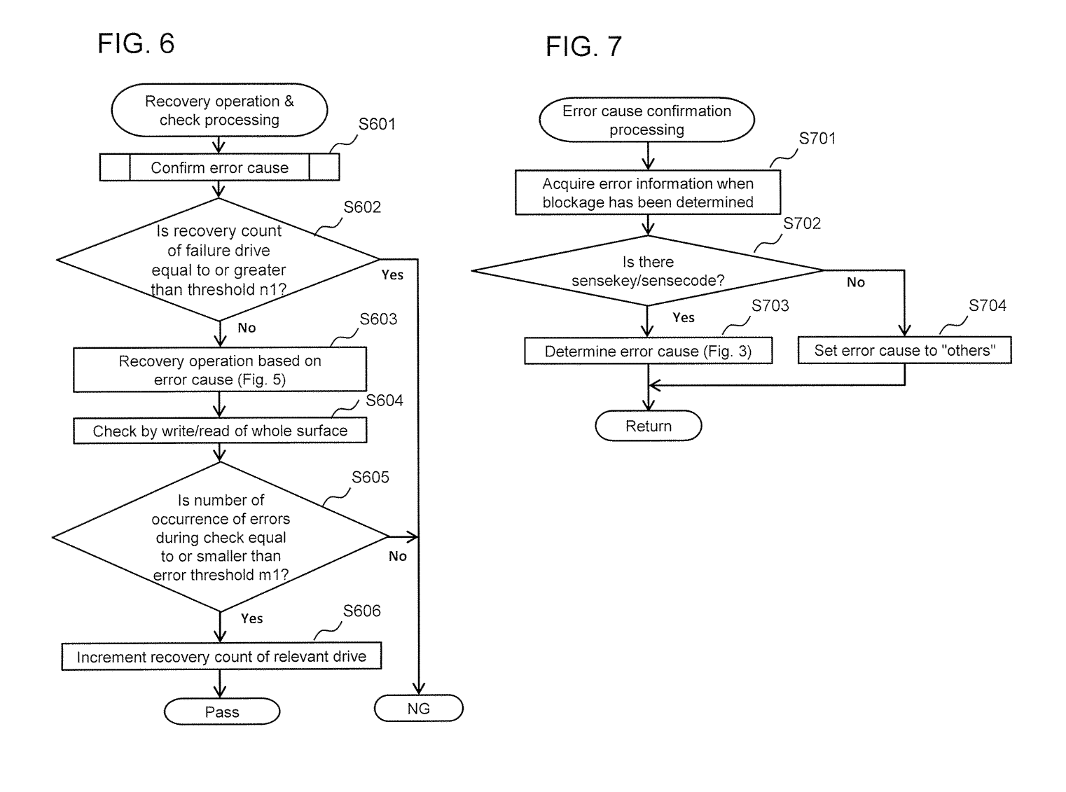

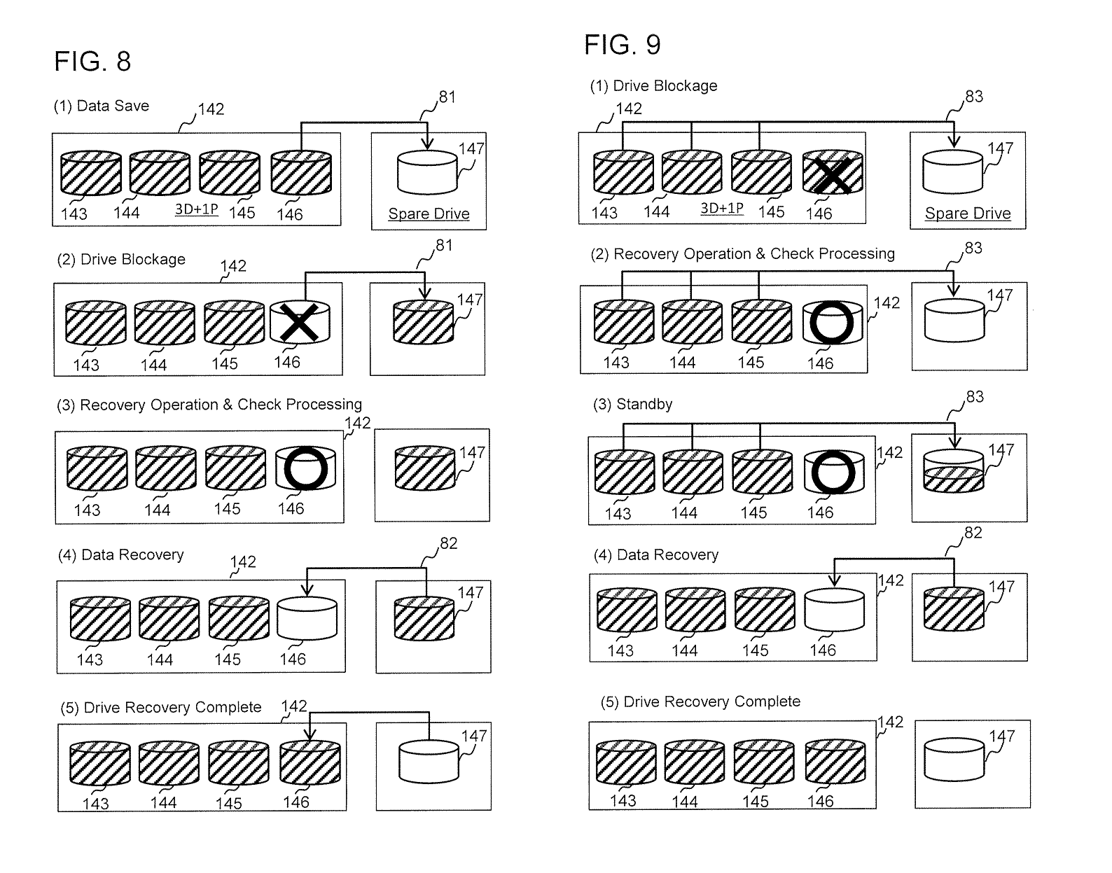

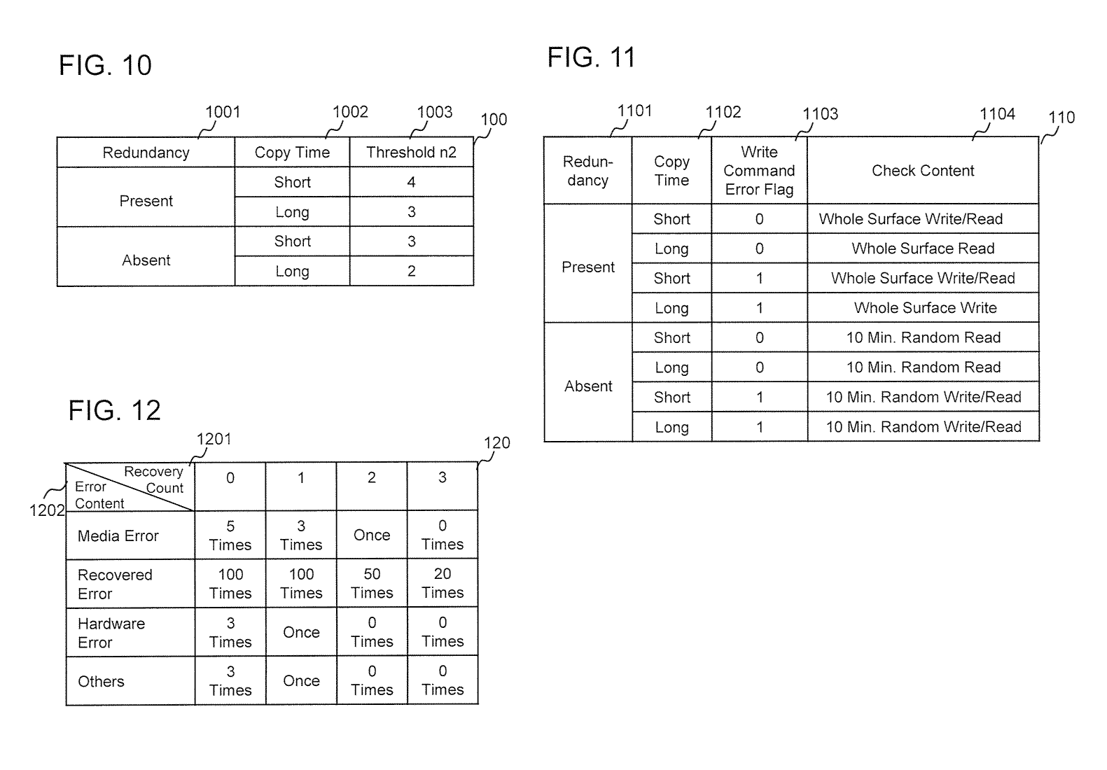

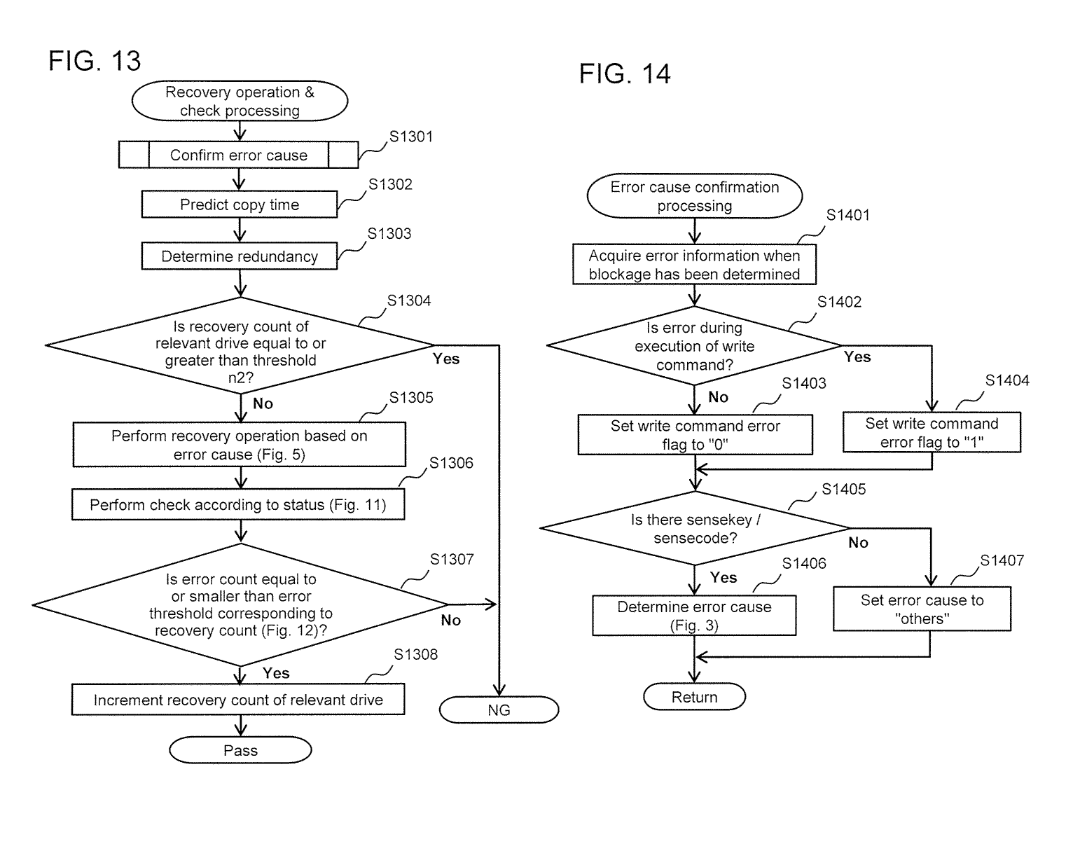

FIG. 3 is a view showing a configuration example of an error cause determination table.

An error cause determination table 30 is a table for determining a cause of error 302 based on a sensekey/sensecode 301. A sensekey/sensecode is an error information reported to the controller or the host when the drive detects an error, which is generated according to the standard.

The cause of error 302 includes a not ready 311, a media error 312, a seek error 313, a hardware error 314, an I/F error 315, and others 316.

Not ready 311 is an error showing a state in which the drive has not been started.

Media error 312 is a read or write error of the media, which includes a CRC (Cyclic Redundancy Check) error caused by write error or read error, or a compare error.

Seek error 313 is a head seek error, which is an error caused by irregular head position or disabled head movement.

Hardware error 314 is an error classified as hardware error other than errors from not ready 311 to seek error 313 and the I/F error 315.

I/F error 315 is an error related data transfer or communication, which includes a parity error.

Others 316 are errors other than the errors included in not ready 311 to I/F error 315.

FIG. 4 is a view showing a configuration example of a recovery count management table.

A recovery count management table 40 is for managing recovery count values of each drive, which is composed of a drive location 401 showing the location information of the drives within the storage system, and a recovery count 402 which is the number of recovery operations and check processing performed in each drive. The drive location 401 is composed of a chassis number showing the number information of the stored chassis, and a drive number showing the information of the insert position within the chassis.

In the recovery count management table 40, the number of recovery operations regarding the failure in each drive is counted, and the possible number of execution of recovery (hereinafter referred to as recovery count) in the recovery operation and check processing described later is restricted. A drive having a high recovery count means that failure has occurred in that drive at a high frequency, so that the probability of occurrence of a serious failure is high, and the possibility of the drive being non-usable is high. Therefore, according to the present invention, the recovery count is restricted so as to eliminate unnecessary recovery operation and check processing and to prevent the occurrence of a fatal failure.

FIG. 5 is a drawing showing a configuration example of a recovery operation determination table.

A recovery operation determination table 50 is a table for determining the recovery operation 502 to be executed to the failed drive based on the cause of error 501. The causes of error 501 are the aforementioned errors from not ready 311 to others 316.

The varieties of the recovery operations 502 are a power OFF/ON 511 for turning the power of the drive body off and then turning it back on, a hardware reset 512 for initializing a portion or all of the semiconductor chips (CPU, drive interface controller etc.) constituting the electric circuit of the drive body in a hardware-like manner, a media/head motor stop/start S13 for stopping and restarting a motor for driving a media or a head, a format S14 for initializing a media, an innermost/outermost circumference seek 515 for moving the head from an innermost circumference to an outermost circumference or from the outermost circumference to the innermost circumference, and a random write/read 516 for writing and reading data in a random manner.

For example, if the cause of error 501 is an I/F error, the power ON/OFF 511 and the hardware reset 512 are executed, but the other operations such as the format S14 or innermost/outermost circumference seek 515 are not executed. This is for saving recovery operations from being performed to areas not related to the area where failure has occurred, so as to shorten the recovery time.

The recovery operations 502 having circle marks (0) entered for the respective errors listed in the cause of error 501 are performed to the failed drive in order from the top of the list. Since the recovery operations closer to the top of the list can realize greater failure recovery, the recovery operations are performed in order from the top. However, regarding an on-going recovery operation, such as in the case of a media error 312, the hardware reset 512 can be performed first instead of the power ON/OFF.

Further, if the recovery of the failed drive (normal operation) has been confirmed, the subsequent recovery operations do not have to be performed. If media error 312 has occurred during random write/read 516, it is possible to re-execute read and write operations, or to perform an exchange processing of the address (LBA: Logical Block Address) where error has occurred.

### <Recovery Operation—Check 1>

FIG. 6 is a flowchart showing the recovery operation and check processing according to embodiment 1. FIG. 7 is a flowchart showing the process for confirming cause of error according to embodiment 1. The processes are described having the CPU 135 as the subject of the processing and the failed drive as the drive 146.

The overall operation of the recovery operation and check processing according to embodiment 1 will be described with reference to FIGS. 6 and 7. The processes of FIGS. 6 and 7 correspond to S102 of FIG. 1, and when the drive is blocked due to failure as shown in S101, the CPU 135 starts the recovery operation and check processing.

In S601, the CPU 135 executes a cause of error confirmation processing of FIG. 7, and confirms the cause of drive blockage.

In S701, the CPU 135 acquires from the memory 138 an error information when the blockage of a drive constituting the RAID group 142 has been determined.

In S702, the CPU 135 determines whether there is a sensekey/sensecode to the acquired error information. If there is a sensekey/sensecode, the CPU 135 executes S703, and if there is no content of a sensekey/sensecode, the CPU executes S704.

In S703, the CPU 135 determines a cause of error in the error cause determination table 30 of FIG. 3. For example, if the sensekey/sensecode is “04H/02H” (H is an abbreviation of Hexadecimal, the “H” may be omitted in the following description), the result of determination of cause of error is set to seek error 313.

In S704, the CPU 135 sets the determination result of cause of error to “other”. After determining the cause of error, the CPU 135 returns the process to S601, and executes the subsequent steps from S602. The determination of the cause of error can be performed not only based on the error information at the time blockage has been determined, but also the error statistical information leading to blockage. For example, if the error information at the time blockage was determined is the seek error 313, but in the error statistical information, it is determined that I/F error 315 has also occurred, the determination result of cause of error is set to both seek error 313 and I/F error 315.

In S602, the CPU 135 confirms the recovery count of the failed drive 146 in the recovery count management table 40, and determines whether the recovery count is equal to or greater than a threshold n1 set in advance. For example, the recovery count 402 where the drive location 401 is “00/01” is “2”, and it is determined whether this value is equal to or greater than the threshold n1. If the value is equal to or greater than the threshold (S602: Yes), the CPU 135 determines that the recovery operation and the check processing cannot be executed (“NG”).

In that case, as shown in FIG. 1, a drive replacement (S103) is executed. If the recovery count is smaller than threshold n1 (“Yes”), the CPU 135 determines that the execution of the recovery operation and check processing is enabled.

In S603, the CPU 135 executes a recovery operation based on the cause of error. In other words, the cause of error is checked against the recovery operation determination table 50 to select the appropriate recovery operation 502. For example, if the cause of error is a seek error 313, the CPU 153 executes one or more operations selected from hardware reset 512, media/head motor stop/start S13 and innermost/outermost circumference seek S14 as the recovery operation 502 with respect to the failed drive, and determines whether the drive is recovered or not. If the determination result of the cause of error during the cause of error confirmation processing is both the seek error 313 and the I/F error 315 as mentioned earlier, the CPU 153 executes one or more recovery operations or a combination of recovery operations having combined one or more recovery operations selected from the recovery operations 502 corresponding to both errors.

If the drive is recovered, the CPU 135 executes S604, and if the drive is not recovered, the CPU 135 determines that it is non-recoverable (“NG”), ends the recovery operation and check processing, and executes request of drive replacement (S103).

In S604, the CPU 135 executes a check operation via write/read of the whole media surface of the drive. The check operation via write/read can be the aforementioned CRC check or a compare check comparing the write data and the read data, for example.

In S605, the CPU 135 determines whether the number of occurrence of errors during the check is equal to or smaller than an error threshold ml or not. The error threshold ml should be equivalent to or smaller than the threshold during normal system operation. The reason for this is because a drive having recovered from failure has a high possibility of experiencing failure again, so that a check that is equivalent to or more severe than the normal check should be executed to confirm the reliability of the recovered drive. If the number of occurrence of errors during the check exceeds the error threshold ml, the CPU 135 determines that the drive is non-recoverable (“NG”). Further, if the number is equal to or smaller than the error threshold ml, the CPU 135 determines that the recovery of the failed drive has succeeded (“Pass”).

Lastly, in S606, the CPU 135 increments a recovery count of the drive having recovered from failure, and updates the recovery count management table 40. Then, the CPU 135 returns the process to S102 of FIG. 1. The CPU 135 executes the processes of S104 and thereafter, and sets the storage system 1 to normal operation status.

As described, the present invention enables to automatically recover the drive where a temporal failure has occurred, and to reuse the same. The present invention enables to eliminate the drive replacement that had been performed by a maintenance personnel, and enables to provide a storage system having an improved operation rate and reduced maintenance processes and costs.

### <First Recovery Operation>

FIG. 8 is a drawing showing a first recovery operation of a failed drive. The first recovery operation is an operation executed when dynamic sparing has succeeded prior to drive blockage, wherein after successive recovery of a failed drive or after drive replacement, data is recovered via copy back processing from the spare drive. The dynamic sparing function is a function to automatically save via on-line the data in a deteriorated drive (drive having a high possibility of occurrence of a fatal failure) to a spare drive based on threshold management of the retry count within each drive.

### (1) Data Save (Before Blockage of Drive)

The CPU 135 copies and saves the data in the deteriorated drive 146 to the spare drive 147 via dynamic sparing 81.

### (2) Drive Blockage

The CPU 135 causes the drive 146 to be blocked after completing the saving of all data via the dynamic sparing 81.

### (3) Recovery Operation and Check Processing

The CPU 135 executes the recovery operation and check processing to the blocked drive 146, and recovers the drive 146.

### (4) Data Recovery

After successful recovery of the blocked drive 146, the CPU 135 copies the data from the spare drive 147 to the drive 146 via copy back processing 82, and recovers the data.

### (5) Completion of Data Recovery

After completing data recovery from the spare drive 147 to the drive 146 via copy back processing, the CPU 135 restores the RAID group 142 from drives 143 to 146, and returns the storage system 1 to the normal operation status.

As described, the failure disk can be recovered automatically by executing the recovery operation and check processing shown in the flowcharts of FIGS. 6 and 7. Thus, the operation rate of to the storage system 1 can be improved and the number of maintenance steps can be reduced.

### <Second Recovery Operation>

FIG. 9 illustrates a second recovery operation of a failed drive. The second recovery operation is an operation executed when data construction to the spare drive 147 via dynamic sparing could not be completed before drive blockage. According to this operation, data construction is executed to the spare drive 147 via correction copy processing 83, wherein if recovery of the failed drive 146 has succeeded and the construction of data to the spare drive 147 has been completed, data is recovered via copy back processing 82.

### (1) Drive Blockage

When the drive 146 in which failure has occurred is blocked, the CPU 135 saves data to the spare drive 147 via a correction copy processing 83.

### (2) Recovery Operation and Check Processing

The CPU 135 executes a recovery operation and check processing to the blocked drive 146, and recovers the drive 146.

### (3) Standby

The CPU 135 enters standby until the data construction to the spare drive 147 by the correction copy processing 83 has completed.

### (4) Data Recovery

After completing data construction to the spare drive 147, the CPU 135 copies data from the spare drive 147 to the drive 146 being recovered in (2) via the copy back processing 82, and executes data recovery of the drive 146.

### (5) Completion of Data Recovery

After completing data recovery from the spare drive 147 to the drive 146 via copy back processing, the CPU 135 restores the RAID group 142 from drives 143 to 146, and returns the storage system 1 to the normal operation status.

As described, according to the second recovery operation, the drive where temporal failure has occurred can be automatically regenerated and reused, similar to the first recovery operation, according to which the operation rate of the storage system can be improved, and the number of maintenance steps and costs can be cut down.

### Embodiment 2

According to the environment of use of the storage system 1 or the status of use of the RAID group configuration and the like, the strictness of the required check or the importance of realizing recovery without replacing the drive may differ. For example, it is necessary to change the contents of the check or the check time based on whether the redundancy of a single drive is maintained even during blockage. For example, in a RAID5 configuration adopting a redundant configuration of 3D+1P, the redundancy is lost when failure occurs to a single drive. Therefore, it is necessary to realize early recovery of the data structure and the redundancy by performing correction copy processing of the spare drive. Therefore, the limitation of the varieties of recovery operations to be performed in response to an error that has occurred, the selection of a simple check and drive replacement at an early stage are performed.

On the other hand, if the RAID group adopts a RAID6 configuration of 3D+2P, the redundancy is not lost even if a single drive is blocked. In such case, by performing an all-recovery operation with respect to an error that has occurred and a detailed and strict check thereof, it becomes possible to enhance reliability by extracting the cause of occurrence of failure that has not actualized or the exchange processing of LBA.

Therefore, according to embodiment 2, an example of varying the contents of the check or the check time based on redundancy, copy time and executed number of times of recovery is illustrated.

### <Determination Table>

FIG. 10 is a view showing a configuration example of a maximum recovery count determination table. A maximum recovery count determination table 100 determines the maximum number of times the recovery operation can be executed based on the redundancy and the copy time.

The maximum recovery count determination table 100 includes a redundancy 1001, a copy time 1002, and a threshold n2 of reference number 1003.

The redundancy 1001 shows whether there is redundancy or not according to the RAID configuration when failure has occurred. That is, as mentioned earlier, if a single storage device constituting a RAID group has been blocked, the redundancy 1001 will be set to “absent” in a RAID5 (3D+1P) configuration, but the redundancy 1001 will be set to “present” in a RAID6 (3D+2P) configuration. The copy time 1002 is an average whole surface copy time actually measured for each drive type. For example, if the copy time is within 24 hours, the copy time 1002 is set to “short”, and if the copy time is over 24 hours, the copy time 1002 is set to “long”. In the present example, the time is classified into two levels, which are “long” and “short”, but it can also be classified into three levels, which are “long”, “middle” and “short”.

If the redundancy 1001 is “present” and the copy time 1002 is “short”, the threshold n2 1003 is set high, so that the possible number of times of execution of recovery operation and check processing is set high. In contrast, if the redundancy 1001 is “absent” and the copy time 1002 is “long”, the threshold n2 1003 is set small. When there is redundancy and the copy time is short, there is still allowance in the failure resisting property, so that the number of times of execution of recovery operation can be set high.

FIG. 11 shows a configuration example of a check content determination table. A check content determination table 110 is a table for determining the check content according to the status when failure has occurred in the drive. The check content determination table 110 includes a redundancy 1101, a copy time 1102, a write command error flag 1103, and a check content 1104.

The redundancy 1101 and the copy time 1102 are the same as the aforementioned redundancy 1001 and copy time 1002.

The write command error flag 1103 is a flag showing whether failure has occurred during execution of a write command from the host 2 and the drive is blocked. This flag is set so that if error has occurred during a write command during blockage, a check must necessarily include a write check.

The check content 1104 shows the content of check performed to the failed drive, wherein an appropriate check content is selected based on the redundancy 1101, the copy time 1102 and the write command error flag 1103. For example, if there is redundancy and the copy time is short, there is allowance in the failure resisting property and time, so that a thorough check, in other words, an “overall write/read” is performed. Further, not only the check content but also the variety, the number and the combination of the recovery operations to be executed in the recovery operation can be varied according to the copy time and the redundancy. The data used for the check can be a specific pattern data or can be a user data.

FIG. 12 shows a configuration example of an error threshold determination table. An error threshold determination table 120 is for determining a recovery reference of the failed drive based on the number of times the recovery operation has been executed, and setting the threshold for each error based on the value of the recovery count. In other words, if the recovery operation has been executed repeatedly, the check result is to be determined in a stricter manner.

The error threshold determination table 120 includes a recovery count 1201 and the error content 1202. As the recovery count 1201 increases, the number of errors allowed by the check decreases. For example, if the error content 1202 is a “media error”, as the recovery count 1201 increases from 0, 1, 2 to 3, the number of errors allowed by the check is reduced from five times, three times, once to zero times, so that a stricter check is performed.

Incidentally, a recovered error is an error saved by the retry processing within the drive, and the access via the write command or the read command has succeeded.

### <Recovery Operation—Check 2>

FIG. 13 is a flowchart showing the recovery operation and check processing according to embodiment 2. FIG. 14 is a flowchart showing the cause of error confirmation processing according to embodiment 2. In the description, the subject of the processing is the CPU 135, and the failed drive is the drive 146.

In S1301, the CPU 135 executes the confirmation processing of the cause of error (FIG. 14).

In S1401, the CPU 135 acquires the error information at the time when blockage has been determined from the memory 138.

In S1402, the CPU 135 determines based on the acquired error information whether the error has occurred during execution of a write command or not. If the error has occurred during execution of a write command (S1402: Yes), the CPU 135 executes S1404, and if not (S1402: No), the CPU 135 executes S1403.

In S1403, the CPU 135 sets a write command error flag to “0”. In S1404, the CPU 135 sets a write command error flag to “1”.

In S1405, the CPU 135 determines whether there is a sensekey/sensecode. If there is (S1405: Yes), the CPU 135 executes S1406, and if not, the CPU executes S1407.

In S1406, the CPU 135 determines the cause of error based on the error cause determination table 30 (FIG. 3).

In S1407, the CPU 135 sets the cause of error to “others”. Thereafter, the CPU 135 returns the process to S1301. Next, the CPU 135 executes the processes of S1302 and thereafter.

In S1302, the CPU 135 predicts the copy time based on the specification of the failed drive (total storage capacity, number of rotations, average seek time, access speed and the like), and determines the level of the copy time.

In S1303, the CPU 135 determines the redundancy. For example, if the RAID group including the drive in which failure has occurred adopts a RAID5 configuration, the CPU determines that redundancy is “absent”, and if the RAID group adopts a RAID6 configuration, the CPU determines that redundancy is “present”.

In S1304, the CPU 135 confirms the recovery count of the failed drive 146 in the recovery count management table 40, and determines whether the recovery count is equal to or greater than the threshold n2 or not. If the recovery count is equal to or greater than the threshold n2 (S1304: Yes), the CPU 135 determines that recovery of the failed drive is impossible, and prompts a maintenance personnel to perform drive replacement of S103 of FIG. 1. If the recovery count is not equal to or greater than the threshold n2 (S1304: No), the CPU 135 executes S1305.

In S1305, the CPU 135 selects recovery operations based on the cause of error from the recovery operation determination table 50, and sequentially executes the operations to the failed drive. If the drive is recovered, the CPU 135 executes S604, and if the drive is not recovered, the CPU determines that the drive is non-recoverable (“NG”), ends the recovery operation and check processing, and executes request of drive replacement (S103).

In S1306, the CPU 135 checks the status of the check corresponding to the status, that is, the status of redundancy, copy time and write command error flag against the check content determination table 110, and determines and executes the content of the check to be performed.

In S1307, the CPU 135 compares the number of occurrence of errors of the result of executing the check with the error threshold in the error threshold determination table 120. For example, if the drive 146 is blocked due to a media error and the recovery count 1201 of the failed drive 146 is “1”, the CPU 135 determines that the recovered drive is usable (“Pass”) and reuses the same if the media error that has occurred during the check is three times or less, the recovered error is 100 times or less, the hardware error is once or less, and other errors is once or less. In contrast, if even one error type exceeds the threshold or if all error types exceed the thresholds, the CPU 135 determines that the recovered drive is non-reusable (“NG”).

Lastly, the CPU 135 increments the recovery count of the corresponding drive (recovered drive 146), and updates the content of the recovery count management table 40 by the value.

As described, similar to embodiment 1, embodiment 2 can also automatically regenerate and reuse the drive in which temporary failure has occurred, so that the storage system can have an improved operation rate and reduced number of maintenance steps and costs. Further, since an appropriate check content corresponding to the status of occurrence of failure can be selected and a strictness of the check based on the recovery history of the failed drive can be realized, the reliability of the storage system can be improved.

### <Data Recovery Area Management Table>

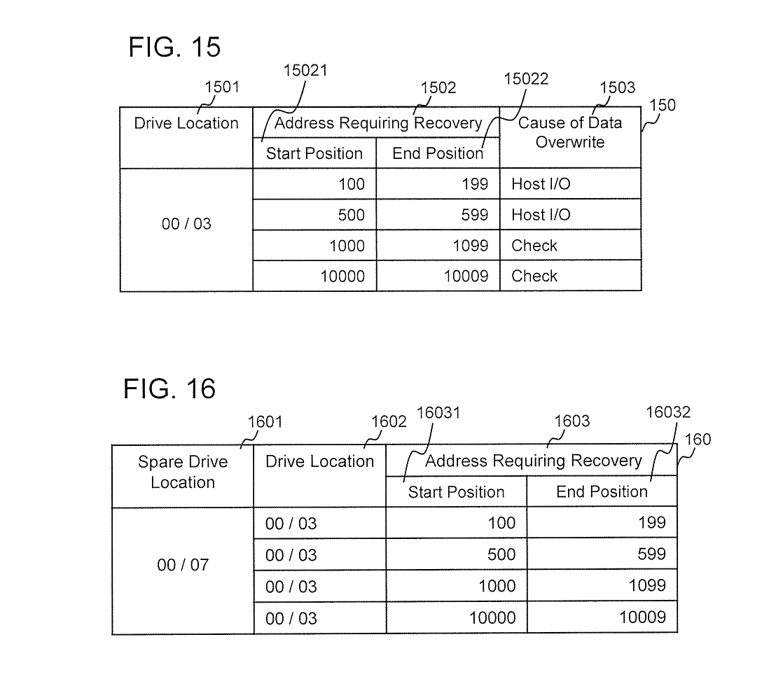

FIG. 15 is a view showing a configuration example of a data recovery area management table of a failed drive. FIG. 16 is a view showing a configuration example of a data recovery area management table of a spare drive.

The data recovery area management table 150 in a failed drive (hereinafter referred to as data recovery area management table 150) and the data recovery area management table 160 in a spare drive (hereinafter referred to as data recovery area management table 160) are for managing the range of data written into the spare drive 147 during recovery of the failed drive 146 (during execution of the recovery operation and check processing), and after recovery of the failed drive 146, this management table is used to reconstruct the data.

The data recovery area management table 150 includes a drive location 1501 showing the position in which the failed drive 146 is mounted, an address requiring recovery 1502 showing the range of data being written, and a cause of data write 1503. In addition, the address requiring recovery 1502 is composed of a write start position 15021 and a write end position 15022. The cause of data write 1503 is for distinguishing whether the data is written by a write I/O from the host 2 or a data written during check.

The data recovery area management table 160 includes a spare drive location 1601 showing the position in which the spare drive 147 is mounted, a drive location 1602 showing the position in which the failed drive 146 is mounted, and an address requiring recovery 1603 showing the written data range, and further, the address requiring recovery 1603 is composed of a write start position 16031 and a write end position 16032.

### <Third Recovery Operation>

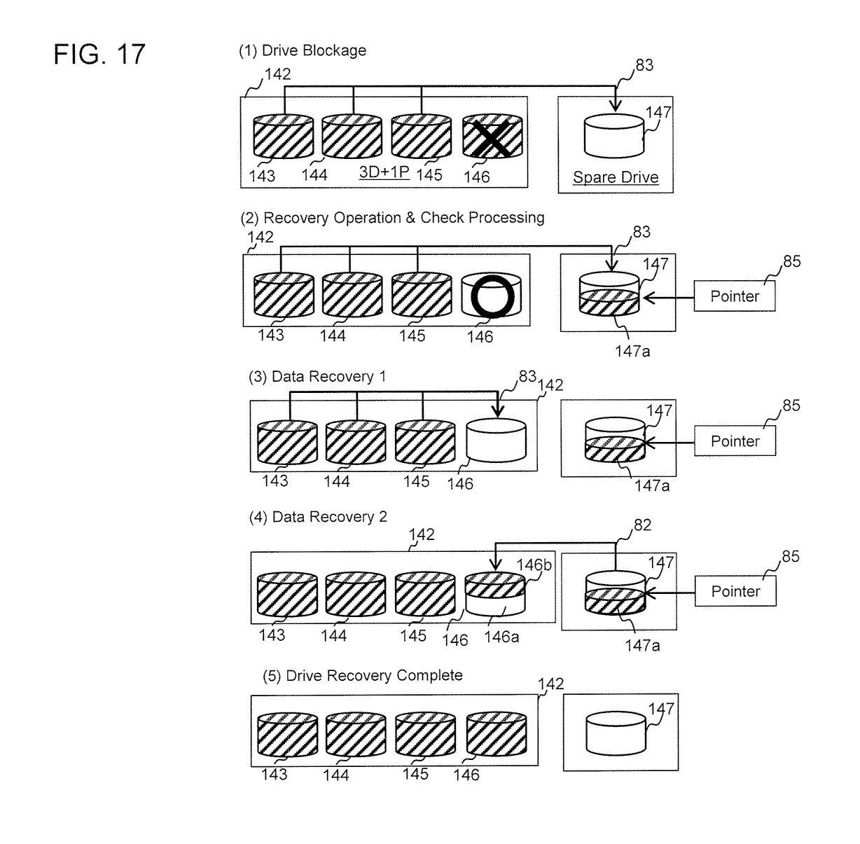

FIG. 17 is a view showing a third recovery operation of the failed drive. According to the third recovery operation, the construction of data to the recovered drive 146 is started even before completing the correction copy processing 83.

According to the second operation described earlier, when the failed drive 146 has been recovered via the recovery operation and check processing, the drive was at a stand-by until the correction copy processing 83 to the spare drive 147 has been completed.

In the third recovery operation, the correction copy destination is changed immediately from the spare drive 147 to the recovered drive 146 without waiting for the completion of the correction copy processing 83, and data recovery other than the data construction completed area 147a written in the spare drive is performed. After completing data recovery, the remaining data is recovered in the recovered drive 146 via a copy back processing 82 from the spare drive 147. As described, by reducing the copy time during the copy back processing 82, it becomes possible to perform data recovery to the recovered drive 146 in a short time.

### (1) Drive Blockage

The CPU 135 constitutes data in the spare drive 147 via correction copy processing 83.

### (2) Recovery Operation and Check Processing

The CPU 135 stores a pointer 85 indicating the data construction completed area 147a of the spare drive 147 before the drive recovers via the recovery operation and check processing.

### (3) Data Recovery 1

The CPU 135 changes the correction copy destination from the spare drive 147 to the recovered drive 146, and performs recovery of the data other than the data already constructed in the spare drive 147 (area denoted by reference number 146b).

### (4) Data Recovery 2

After completing the correction copy processing 83, the CPU 135 refers to the pointer 85 of the data constructed in the spare drive 147, and executes the copy back processing 82 from the spare drive 147 to the recovered drive 146. That is, the data in the data construction completed area 147a in the spare drive 147 is copied to a data non-constructed area 146a of the recovered drive 146.

### (5) Completion of Data Recovery

After completing data recovery from the spare drive 147 to the drive 146 via the copy back processing 82, the CPU 135 restores the RAID group 142 from drives 143 to 146, and returns the storage system 1 to a normal operation status.

As described, similar to the first and second recovery operations, the third recovery operation enables to automatically regenerate and reuse the drive in which a single or temporary failure has occurred. Further, since the amount of data to be subjected to copy back can be reduced by switching the correction copy destination, the data recovery time can be shortened.

### <Fourth Recovery Operation>

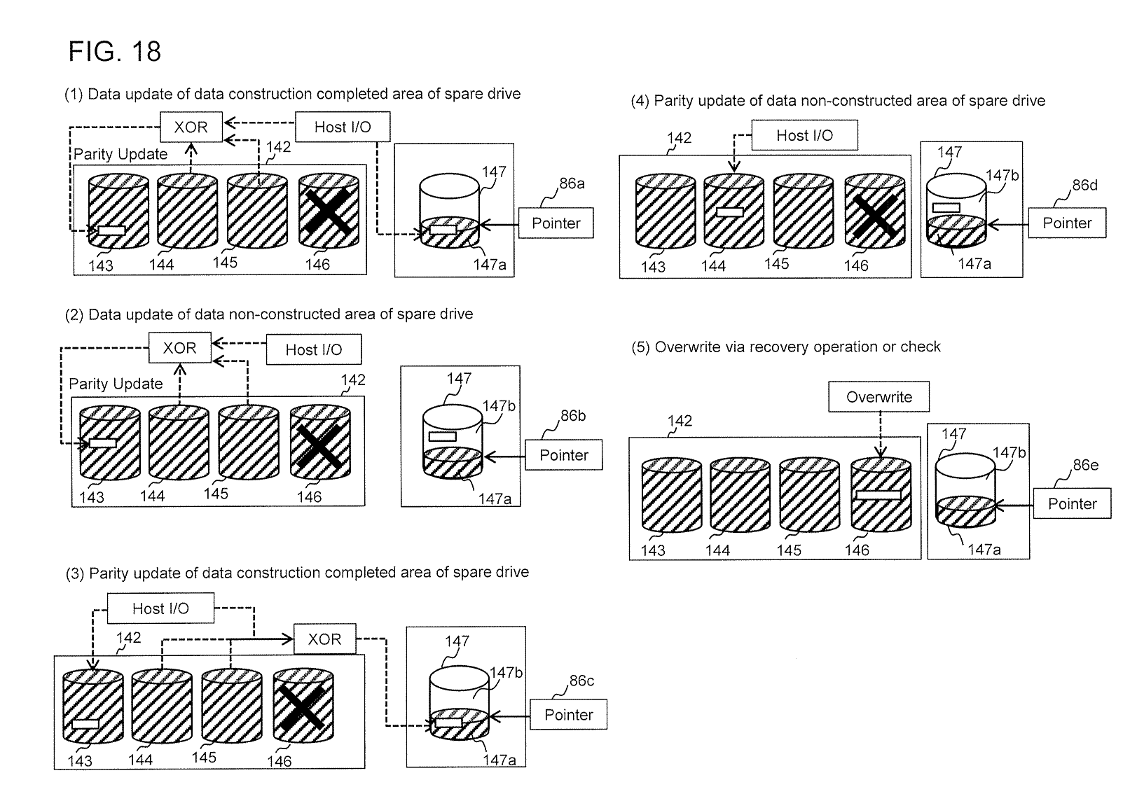

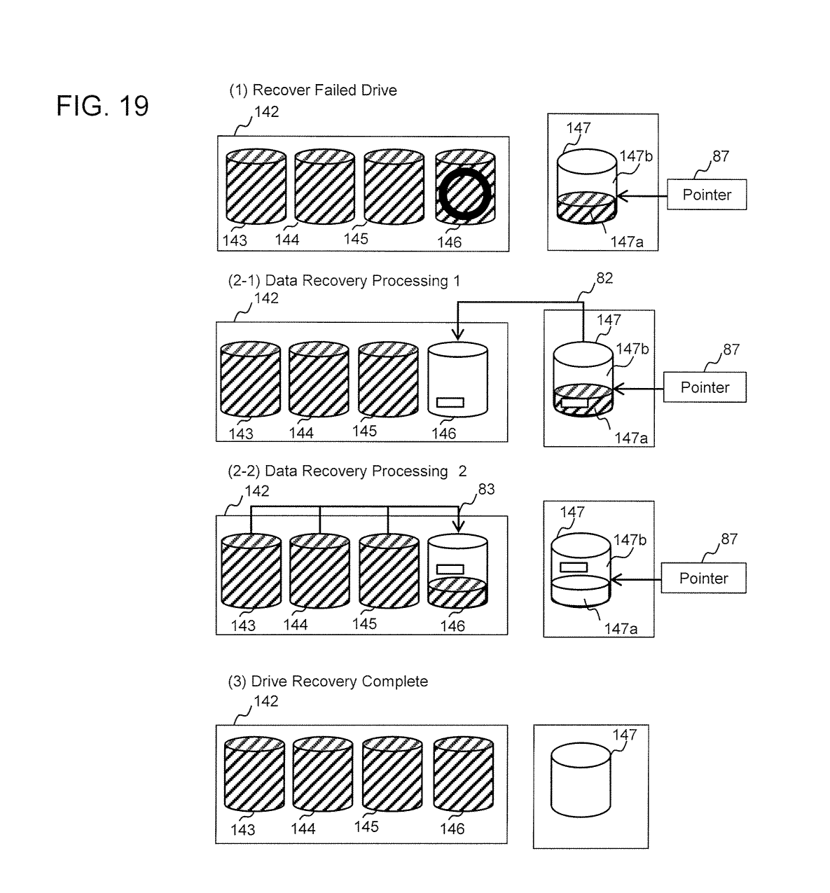

FIG. 18 is a view showing a data and parity update operation via a fourth recovery operation of a failed drive. FIG. 19 shows a data recovery processing via the fourth recovery operation of the failed drive. The fourth recovery operation performs data recovery of the recovered drive using the user data originally stored in the drive.

According to the present invention, a blocked drive which was originally a data drive is recovered and used, so that correct data is originally stored in the drive, and data recovery can be completed at an early stage by updating only the data in the area listed below.

Therefore, the following addresses are managed as the “address requiring recovery” (data update range) in the data recovery area management table 150:

(a) address overwritten by the host I/O after blockage;

(b) address overwritten during recovery operation or address where reassignment has been performed; and

(c) address overwritten during check operation.

Then, after drive recovery, if the area corresponding to the “address requiring recovery” exists in the spare drive 147, only the data in that area is reflected in the recovered drive 146 via the copy back processing 82. Further, if there is no data in the spare drive 147, data is constructed in the recovered drive 146 via the correction copy processing 83. According to this operation, data recovery can be completed in a shorter time.

As shown in (1) through (5) of FIG. 18, the CPU 135 manages the data construction completed area 147a of the spare drive 147 via pointers 86a through 86e (hereinafter also collectively denoted by reference number 86). Incidentally, as the elapse of time, the area where data has been constructed via the correction copy processing increases, and the point position gradually changes. Therefore, at first, the addresses of (a) through (c) are stored in the data recovery area management table 150 as the “address requiring recovery”. Then, the true “address requiring recovery” is specified from the pointer 86 at the time of recovery of the failed drive 146.

### (1) During Data Update of Data Construction Completed Area 147a in Spare Drive

The CPU 135 enters the address which has been overwritten in the data recovery area management table 150, and overwrites data in the spare drive 147. Further, the CPU 135 generates parity data by the data of the host I/O and the remaining two drives 144 and 145, and overwrites the data in the parity drive 143.

### (2) During Data Update of Data Non-Constructed Area 147b in Spare Drive

The CPU 135 enters the address which has been overwritten in the data recovery area management table 150, generates parity data by the data of the host I/O and the remaining two drives 144 and 145, and overwrites the data in the parity drive 143.

### (3) During Parity Update of Data Construction Completed Area 147a in Spare Drive

When there is a data update request to a non-blocked drive within the RAID group, and a parity update request to the address corresponding to the blocked drive occurs, the CPU 135 performs data update of the data drive. Further, the CPU 135 generates parity data via the host I/O data and the remaining two drives 144 and 145, overwrites the data in the spare drive 147, and enters that address in the data recovery area management table 150.

### (4) During Parity Update of Data Non-Constructed Area 147b in Spare Drive

When there is a data update request to a non-blocked drive 143 within the RAID group, and a parity update to a corresponding address in the blocked drive 146 occurs, the CPU 135 performs data update of the corresponding data drive 143, and enters the address where parity date should have been updated in the data recovery area management table 150 (FIG. 15).

### (5) When Overwrite is Performed Via Recovery Operation and Check Processing

The address where overwrite had been performed is entered in the data recovery area management table 150, and overwrite is performed in the recovery target drive 146.

Next, the recovery of the failed drive 146 and data recovery thereof will be described with reference to FIG. 19.

### (1) Recovery of Failed Drive

The CPU 135 performs recovery of the failed drive 146 via a recovery operation and check processing. If recovery of the drive succeeds, the CPU 135 executes the check processing and determines whether the drive can be reused or not. If it is determined that the drive is reusable, the CPU 135 executes the following data recovery operation.

### (2-1) Data Recovery Operation 1

The CPU 135 refers to a data recovery area management table 150, and if a cause of data overwrite 1503 is “host I/O” and the data of the address requiring recovery 1502 is stored in the data construction completed area 147a of the spare drive 147, data recovery to the recovered drive 146 via copy back processing 82 is executed.

### (2-2) Data Recovery Operation 2

The CPU 135 refers to the data recovery area management table 150, and if the cause of data overwrite 1503 is “host I/O” and the data of the address requiring recovery is in area 147b instead of in the data construction completed area 147a of the spare drive 147, data recovery is executed via correction copy processing 83. Further, regarding the area of the address requiring recovery when the cause of data overwrite 1503 is “check”, data recovery is executed similarly via correction copy processing 83.

### (3) Completion of Data Recovery (Regeneration of Failed Drive)

After completing data recovery in the drive 146 via copy back processing 82 or correction copy processing 83, the CPU 135 restores the RAID group 142 from drives 143 to 146, and returns the storage system 1 to the normal operation status.

As described, according to the fourth recovery operation, the drive in which failure has occurred can be regenerated automatically and reused, similar to the first to third recovery operations. Further, since the RAID group 142 can be restored by copying only the data stored in the updated area to the recovered drive, the recovery time from failure can be shortened.

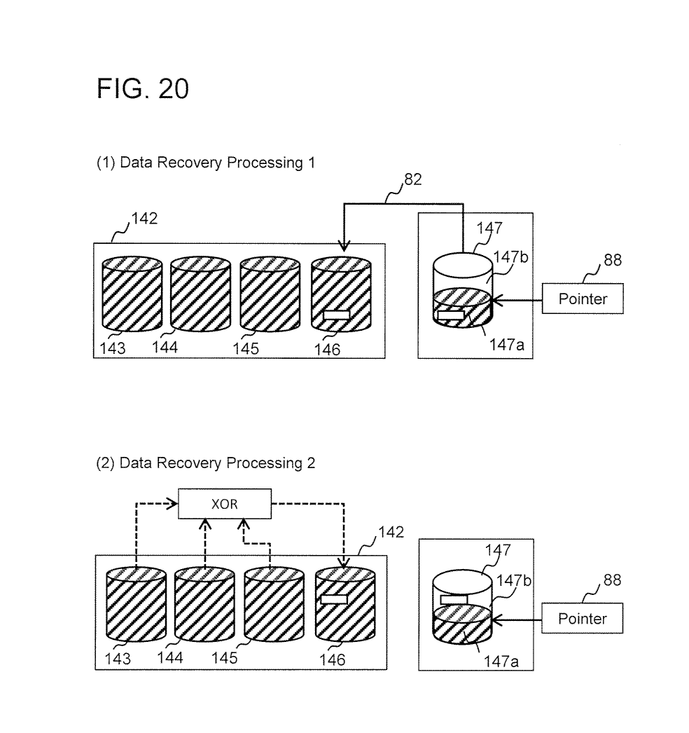

FIG. 20 is a view showing a fifth recovery operation for recovering a failed drive. According to the present example, user data is used as it is to perform recovery operation and check processing, similar to the fourth recovery operation.

The user data is used as it is to perform writing of data in the recovery operation or the check processing, and the stored user data is not changed. In addition, only the address having been overwritten via a host I/O is recovered, so as to complete the data recovery operation of the drive being recovered from failure at an early stage. However, if data having a specific pattern such as a format is written without using user data, an operation for recovering data of the data write area becomes necessary. Only the differences with the fourth recovery operation are explained in the description of the fifth recovery operation.

### (1) Data Recovery Operation 1

The data recovery operation 1 reflects the update data to the data constructed area 147a of the spare drive 147 to the recovery target drive 146. Therefore, the CPU 135 uses the data in the spare drive 147 to overwrite the data via copy back processing to the same address of the recovery target drive 146.

### (2) Data Recovery Operation 2

Data recovery operation 1 is for reflecting the update data of the data non-constructed area 147b in the spare drive 147 to the recovery target drive 146. Therefore, the CPU 135 generates data of the relevant area based on the data stored in the three drives 143, 144 and 145 constituting the RAID group 142, and writes the data in the relevant area (same address area) of the recovered drive 146.

As described, by performing recovery operation and check processing using user data without any change, the restoration and recovery of redundancy of the RAID group using a normal drive can be realized speedily by simply reflecting only the areas subjected to data update via the host 2 in the recovered drive 146.

As described, according to the fifth recovery operation, the drive in which failure has occurred can be regenerated automatically and reused, similar to the first to fourth recovery operations.

As described, according to embodiment 2, the drive in which failure has occurred can be regenerated automatically and reused similar to embodiment 1, so that the operation rate of the storage system can be improved and the number of maintenance steps and costs can be reduced. In addition, the reliability of the storage system can be enhanced by selecting an appropriate check content according to the status of occurrence of failure, and by requiring a strict check corresponding to the recovery history of the failed drive.

### <Redundancy Recovery Operation During Reappearance of Failure>

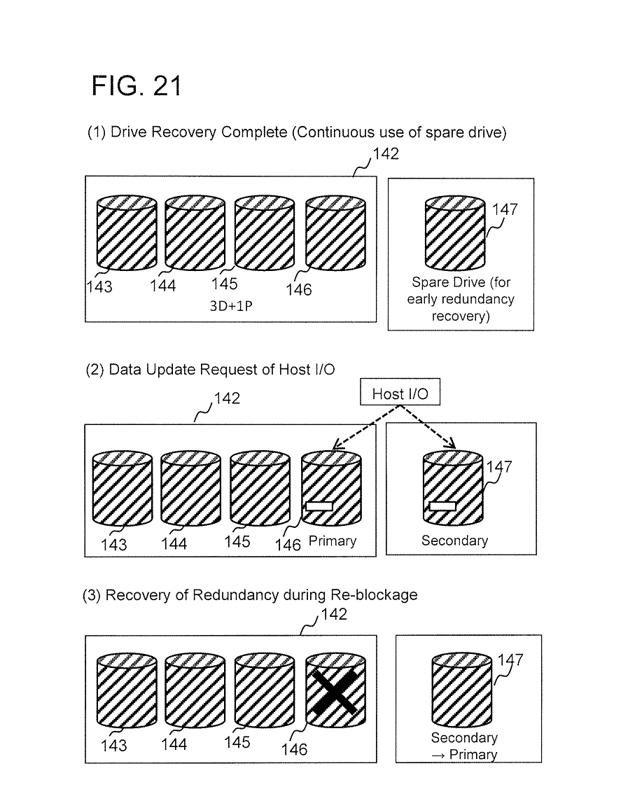

Next, the response to a case where a recovered drive is blocked again in a short time will be described with reference to FIGS. 21 through 23.

### <Redundancy Recovery Operation 1>

FIG. 21 is a view showing a first redundancy recovery operation when reappearance of failure occurs in a recovered drive. In the case of FIG. 21, all identical data as the recovered drive 146 is stored in the spare drive 147. Even when the recovery operation via the recovery operation and check processing is completed, the spare drive 147 is not released immediately but used in parallel with the recovered drive 146, so as to realize an early recovery of redundancy when the drive is blocked again.

If the check is not sufficient, the recovered drive may be blocked again in a short time. Therefore, after recovery of the drive 146, the spare drive 147 is not released and the data stored therein is managed until the spare drive is needed for other purposes of use. Thereby, the construction of data in the spare drive 147 can be completed speedily even if the recovered drive 146 is blocked again, and data redundancy can be recovered immediately.

According to the example of FIG. 21, when a write via a host I/O occurs, write data is written into both the recovered drive 146 and the spare drive 147, so as to realize a mirror configuration with the recovered drive 146 acting as a primary drive and the spare drive 147 acting as a secondary drive. The operation will be described below.

### (1) Completion of Data Recovery

When data recovery from the spare drive 147 to the drive 146 via copy back processing 82 or correction copy processing 83 is completed, the CPU 135 restores the RAID group 142 from drives 143 to 146, and returns the storage system 1 to the normal operation status. Thereafter, the CPU 135 continues to use the spare drive 147 as a drive for early redundancy recovery.

### (2) Data Update Request of Host I/O

If an update request occurs via a host I/O, the CPU 135 always updates the data in the spare drive 147 (area shown by white rectangle). Then, the CPU 135 always also updates the data in the spare drive 147 simultaneously, so that the data consistency with the recovered drive 146 is maintained.

### (3) Recovery of Redundancy During Re-Blockage

When failure occurs to the recovered drive 146 and the drive is blocked again, since identical data as the recovered drive 146 is stored in the spare drive 147, the original RAID group can be restored immediately by switching the spare drive 147 to be used as the primary data drive, so that the redundancy can be recovered.

### <Redundancy Recovery Operation 2>

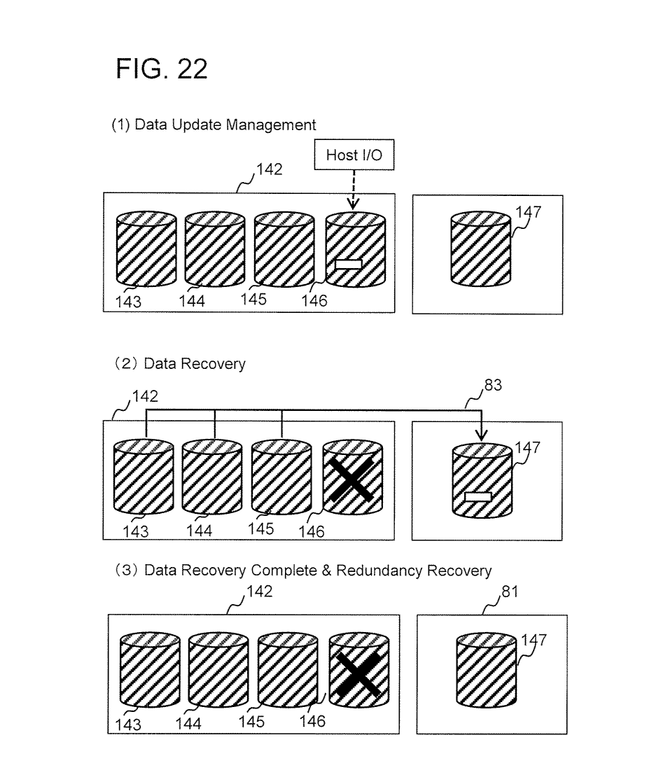

FIG. 22 is a view showing a second redundancy recovery operation during reappearance of failure in a recovered drive. In FIG. 22, when a write I/O request occurs from the host 2, the write area is stored in the memory, and the data of the spare drive 147 is updated when necessary.

That is, the data difference between the recovered drive 146 and the spare drive 147 is stored in the data recovery area management table 160. Then, when the recovered drive 146 is re-blocked in a short time, the area stored in the data recovery area management table 160 is reflected in the spare drive 147 to recover the redundancy.

### (1) Data Update Management

When the write I/O from the host 2 is executed to the recovered drive 146, the CPU 135 enters the data in the data recovery area management table 160. Actually, a write start position and a write end position are stored in the fields of a write start position 16031 and a write end position 16032.

### (2) Data Recovery

When the recovered drive 146 is blocked again, the CPU 135 specifies the data update area of the recovered drive 146 by referring to the write start position 16031 and the write end position 16032 of the data recovery area management table 160, and recovers the data via correction copy processing 83 to the corresponding area of the spare drive 147.

### (3) Completion of Data Recovery and Redundancy Recovery

After the data recovery in the spare drive 147 is completed, the CPU 135 switches the use of the spare drive as the data drive, according to which the RAID group 142 including the spare drive 147 can be reconstructed and the redundancy can be recovered speedily.

### <Redundancy Recovery Operation 3>

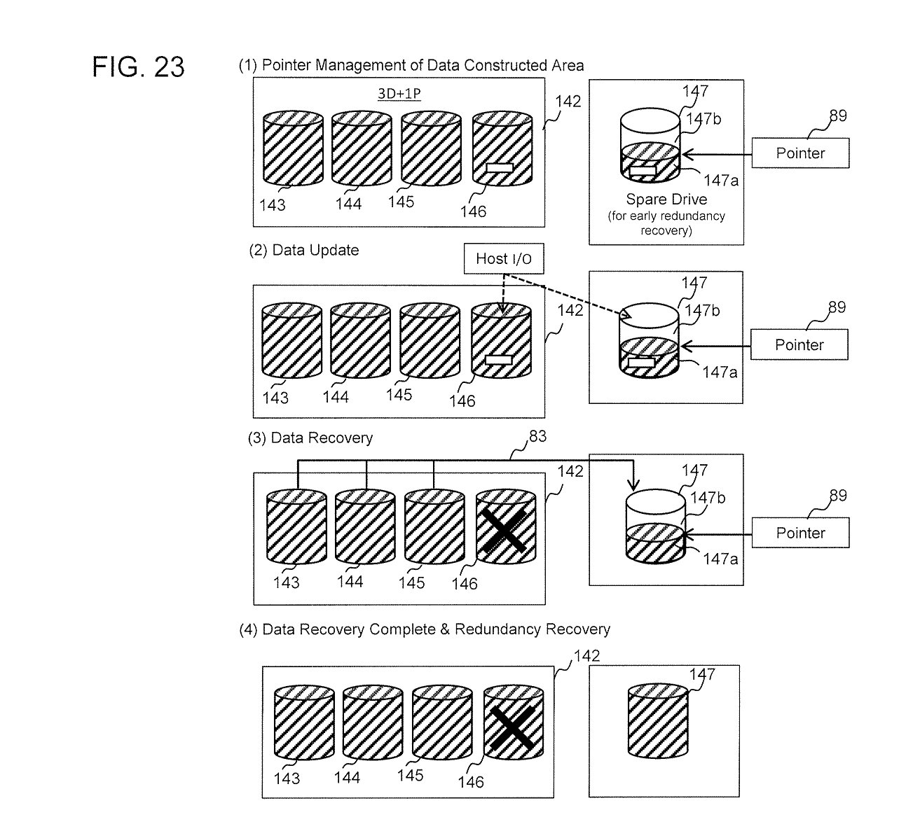

FIG. 23 is a view showing a third redundancy recovery operation during reappearance of failure in a recovered drive.

The present example is a redundancy recovery operation executed when all the data in the recovered drive 146 is not stored in the spare drive 147, wherein the data construction completed area 147a of the spare drive 147 (area reflecting the data in the recovered drive 146) is managed via a pointer. Then, when there is a write I/O from the host 2 to the data construction completed area 147a, the data is stored in both the recovered drive 146 and the spare drive 147. When re-blockage occurs, data is constructed via correction copy processing 83 to the data non-constructed area 147b of the spare drive 147 using drives 143, 144 and 145.

### (1) Pointer Management of Data Constructed Area

The CPU 135 manages the boundary between the data construction completed area 147a which is the effective data area within the spare drive 147 and the data non-constructed area 147b using a pointer 89.

### (2) Data Update

If the data write position via the write I/O request from the host 2 is the data construction completed area 147a of the spare drive 147, the CPU 135 updates the data in the given area of both the recovered drive 146 and the spare drive 147. If the data write position is in the data non-constructed area 147b, the CPU 135 only updates data in the recovered drive 146, and does not perform update of data in the spare drive 147.

### (3) Data Recovery

When the recovered drive 146 is blocked again, the CPU 135 writes the data generated via correction copy processing 83 to the data non-constructed area 147b of the spare drive 147 based on the remaining three drives 143, 144 and 145, and recovers the data. On the other hand, the data construction completed area 147a is not subjected to any operation.

### (4) Completion of Data Recovery and Redundancy Recovery

After the data recovery in the spare drive 147 is completed, the use of the drive is switched to data drive, so that the RAID group can be composed of drives 143, 144 and 145 and the spare drive 147, by which redundancy is recovered.

As described, even if the drive 146 after recovery is blocked again in a short time, the recovery time of redundancy can be shortened by constructing data of only the area where no effective data is stored in the spare drive 147 via correction copy processing 83.

After drive recovery and before elapse of a given time, a stricter recovery operation and check processing can be executed in the recovery operation and check processing performed again. For example, a drive having a recovery count of “1” which has been blocked again by media error 312 before the elapse of a given time is subjected to all the corresponding checks during the recovery operation 502. Further, the recovery count 1201 of the error threshold determination table 120 is set to “2” instead of “1”, so that the error threshold is lowered in order to strictly determine the level of reliability. Thus, the reliability of the failed drive can be highly appreciated. The aforementioned given time can be set in advance in the storage system 1, or the value received via the input device of the maintenance terminal 15 can be used.

As described, even if the recovered drive has been blocked again in a short time, the RAID group can be recovered quickly, and the reliability and the operation rate of the storage system can be improved.

The present invention is not restricted to the above-illustrated preferred embodiments, and can include various modifications. The above-illustrated embodiments are mere examples for illustrating the present invention in detail, and they are not intended to restrict the present invention to include all the components illustrated above. Further, a portion of the configuration of an embodiment can be replaced with the configuration of another embodiment, or the configuration of a certain embodiment can be added to the configuration of another embodiment. Moreover, a portion of the configuration of each embodiment can be added to, deleted from or replaced with other configurations.

Furthermore, a portion or whole of the above-illustrated configurations, functions, processing units, processing means and so on can be realized via a hardware configuration such as by designing an integrated circuit. Further, the configurations and functions illustrated above can be realized via software by the processor interpreting and executing programs realizing the respective functions.

The information such as the programs, tables and files for realizing the respective functions can be stored in a storage device such as a memory, a hard disk or an SSD (Solid State Drive), or in a memory media such as an IC card, an SD card or a DVD.

Only the control lines and information lines considered necessary for description are illustrated in the drawings, and not necessarily all the control lines and information lines required for production are illustrated. In actual application, it can be considered that almost all the components are mutually coupled.

### REFERENCE SIGNS LIST

1 Storage system
2 Host terminal
13 Disk controller unit
14 Disk drive unit
15 Maintenance terminal
30 Error cause determination table
40 Recovery count management table
50 Recovery operation determination table
100 Maximum recovery count determination table
110 Check content determination table
120 Error threshold determination table
131 Controller package
132 Channel control unit
133 Cache memory
134 Data controller
135 CPU
136 Shared memory
137 Disk control unit
138 Local memory
141 Expander
142 RAID group
143, 144, 145, 146 Data drive
147 Spare drive
150, 160 Data recovery area management table

1. A storage system coupled to a host computer, the storage system comprising:
a controller;
a memory;
a plurality of data storage devices for storing data sent from the host computer; and
one or more spare storage devices to be used for replacing the data storage devices;
wherein two or more of said data storage devices constitute a RAID group;
and when it is determined that the data storage device is to be blocked due to failure, the controller
records instruction data indicating a region of data stored in the spare storage device until the blocked data storage device is recovered; and
executes a failure recovery processing corresponding to a content of failure and a predetermined check processing to the data storage device, by writing the data stored in the region of the spare storage device indicated by the instruction data back to the blocked data storage device, at a time point when the blocked data storage device has recovered.

2. The storage system according to claim 1, wherein the failure is one of the following failures of the data storage device:
(1) start failure;
(2) access failure to storage media;
(3) seek operation failure;
(4) hardware operation failure; or
(5) interface access failure.

3. The storage system according to claim 1, wherein the failure recovery processing is one or more of the following operations (a1) through (a6) executed by the controller to the data storage device:
(a1) power OFF/ON operation;
(a2) hardware reset operation;
(a3) motor stop and restart operation;
(a4) initialization operation of storage area;
(a5) move operation of the storage area to read section; and
(a6) read/write operation of the storage area.

4. The storage system according to claim 1, wherein the check processing is one of the following processes:
(b1) reading of data of the whole storage area;
(b2) writing of data of the whole storage area;
(b3) reading of data and writing of data of the whole storage area;
(b4) reading of data of a predetermined time to the storage area;
(b5) writing of data of a predetermined time to the storage area;
(b6) writing of data and reading of data of a predetermined time to the storage area;
(b7) writing of data and reading of data of the whole storage area, and comparing of write data and read data; or
(b8) writing of data and reading of data of a predetermined time to the storage area, and comparing of the write data and the read data.

5. The storage system according to claim 1, wherein
the controller manages a number of times of execution of recovery and check in which the recovery processing and the check processing have been executed for each data storage device.

6. The storage system according to claim 5, wherein
the controller does not execute the recovery processing and check processing if the number of times of execution of recovery and check exceeds a predetermined threshold value.

7. The storage system according to claim 6, wherein
the controller determines the threshold value
based on the presence or absence of redundancy at the time failure occurs; and
based on a storage time of all stored data of the data storage device where failure has occurred to the spare storage device.

8. The storage system according to claim 7, wherein
if the occurrence of failure is caused by an I/O access from the host computer,
the controller determines a type of the check processing based on a combination of two or more of the following: presence or absence of redundancy, storage time, or I/O access type, determines a permitted number of times of failure for each failure type by the check processing according to the number of times of execution of recovery and check processing, and if the number of times of occurrence of failure occurred by the check processing is smaller than the permitted number of times of failure, cancels blockage of the blocked data storage device.

9. The storage system according to claim 1, wherein the controller
manages a number of times of execution of recovery and check processing in which the recovery processing and check processing have been executed for each data storage device;
determines a permitted number of times of failure for each failure type by the check processing according to the number of times of execution of recovery and check processing; and
if the number of times of occurrence of failure occurred by the check processing is smaller than the permitted number of times of failure, cancels the blockage of the data storage device in the blocked state.

10. The storage system according to claim 1, wherein
when the data storage device where failure has occurred has been recovered by the failure recovery processing and check processing, the controller
switches a storage destination of the data from the spare storage device to the recovered data storage device.

11. The storage system according to claim 1, wherein
when a data update request occurs from the host computer to the data storage device or the spare storage device constituting the RAID group during execution of the recovery processing or the check processing, the controller
stores a data update range to the memory or the data storage device; and
stores the data in the data update range to the data storage device having the blocked state cancelled.

12. A failure recovery method of a storage device, comprising:
storing data from a host computer to a data storage device, and constituting a RAID group by two or more said data storage devices;
wherein when it is determined that the data storage device is to be blocked due to failure, the method further comprises
recording instruction data indicating a region of data stored in the spare storage device until the blocked data storage device is recovered; and
executing a failure recovery processing corresponding to a content of failure and a predetermined check processing to the data storage device, by writing the data stored in the region of the spare storage device indicated by the instruction data back to the blocked data storage device, at a time point when the blocked data storage device has recovered.

13. The failure recovery method of a storage device according to claim 12, wherein
the failure recovery processing selects and executes one or more of the following operations:
(a1) power OFF/ON;
(a2) hardware reset;
(a3) motor stop and restart;
(a4) initialization of storage area;
(a5) moving of the storage area to read section; and
(a6) reading/writing of the storage area; and
the check processing selects and executes one of the following processes:
(b1) reading of data of the whole storage area;
(b2) writing of data of the whole storage area;
(b3) reading of data and writing of data of the whole storage area;
(b4) reading of data of a predetermined time to the storage area;
(b5) writing of data of a predetermined time to the storage area;
(b6) writing of data and reading of data of a predetermined time to the storage area;
(b7) writing of data and reading of data of the whole storage area, and comparing of write data and read data; or
(b8) writing of data and reading of data of a predetermined time to the storage area, and comparing of the write data and the read data.

14. A storage system coupled to a host computer and a maintenance terminal, the storage system comprising:
a controller;
a memory;
a plurality of data storage devices for storing data sent from the host computer; and
one or more spare storage devices to be used for replacing the data storage devices;
wherein two or more of said data storage devices constitute a RAID group;
and when it is determined that a data storage device is to be blocked due to failure, the controller
records instruction data indicating a region of data stored in the spare storage device until the blocked data storage device is recovered; and
executes a failure recovery processing corresponding to a content of failure and a predetermined check processing to the data storage device, by writing the data stored in the region of the spare storage device indicated by the instruction data back to the blocked data storage device, at a time point when the blocked data storage device has recovered;
wherein the failure recovery processing is one or more of the following operations executed by the controller:
(a1) power OFF/ON;
(a2) hardware reset;
(a3) motor stop and restart;
(a4) initialization of storage area;
(a5) move of the storage area to read section; and
(a6) reading/writing of the storage area:
wherein the check processing is one of the following processes:
(b1) reading of data of the whole storage area;
(b2) writing of data of the whole storage area;
(b3) reading of data and writing of data of the whole storage area;
(b4) reading of data of a predetermined time to the storage area;
(b5) writing of data of a predetermined time to the storage area;
(b6) writing of data and reading of data of a predetermined time to the storage area;
(b7) writing of data and reading of data of the whole storage area, and comparing of write data and read data; or
(b8) writing of data and reading of data of a predetermined time to the storage area, and comparing of the write data and the read data:
wherein the controller
stores a number of times of execution of recovery and check in which the failure recovery processing and the check processing have been executed for each data storage device in the memory;
determines a threshold value based on the presence or absence of redundancy at the time failure occurs, and based on a storage time of all stored data of the data storage device where failure has occurred to the spare storage device;
does not execute the failure recovery processing and check processing if the number of times of execution of recovery and check exceeds the threshold value;
determines a type of the check processing based on a combination of two or more of the following: presence or absence of redundancy, storage time, or I/O access type;
determines a permitted number of times of failure for each failure type by the check processing according to the number of times of execution of recovery and check processing;
if the number of times of occurrence of failure occurred by the check processing is smaller than the permitted number of times of failure, cancels the blockage of the data storage device in the blocked state; and
when the data storage device where failure has occurred has been recovered by the failure recovery processing and check processing, the controller
switches a storage destination of the regenerated data from the spare storage device to the recovered data storage device.
